(19) United States
(12) Patent Application Publication
(10) Pub. No.: US 2002/0035624 A1
(43) Pub. Date: Mar. 21, 2002

(54) Gateway and a method for operating the same

(75) Inventor: Jun-hyeong Kim, Anyang-city (KR)

Correspondence Address: SUGHRUE, MION, ZINN, MACPEAK & SEAS, PLLC, 2100 Pennsylvania Avenue, N.W., Washington, DC, 20037-3213, US

(73) Assignee: SAMSUNG ELECTRONICS CO., LTD.

(21) Appl. No.: 09/900,460

(22) Filed: Jul. 9, 2001

(30) Foreign Application Priority Data
Sep. 19, 2000 (KR) 2000-55033

(51) Int. Cl. G06F 15/177; G06F 15/16

(52) U.S. Cl. 709/222; 709/249; 709/245

(57) ABSTRACT

A gateway and a method for operating the same, enabling a mutual data intercommunication between information appliances connected to an internal network and information appliances connected to an exterior network, including a first interface for communicating with information appliances connected to an internal network; a second interface for communicating with information appliances connected to an external network. The invention further includes a controller for, if a control request with respect to any of the information appliances connected to the internal network is received from the information appliances connected to the external network, requesting a function performance to a corresponding appliance according to requested control contents. Thereby internal users are enabled to use the Internet through the information appliances connected to the internal network as well as external users to control the information appliances connected to the internal network.

### BACKGROUND OF THE INVENTION

1. Field of the Invention

The present invention relates to a network apparatus and a method for operating the same, and more particularly, to a gateway and a method for operating the same, enabling information appliances connected to an internal network and information appliances connected through an external network to perform mutual data communications.

The present invention is based upon Korean Patent Application No. 2000-55033, filed Sep. 19, 2000, which is incorporated herein by reference.

2. Description of the Related Art

In recent years, the Internet-using population has rapidly increased together with the prevalence of the necessity of the Internet use, and the rapid supply of high speed communication lines to almost every home. Further, complying with such trend, enterprises market diverse digital information electronic appliances, having additional network communication functions of allowing the Internet to be used through the electronic appliances at homes.

The addition of the communication function to the electronic appliances used at home, as stated above, allows a network to be constructed in order for mutual communications to be available between electronic appliances, and between the electronic appliances and information terminals at home. Such a constructed network may be defined as a “home network”, or as a “home area network”.

In order to substantially realize the home network, various network protocols based on the Internet Protocol (IP) are used. However, it is not easy for home information appliance users to understand the protocols and construct a network.

Further, since users at homes are usually provided, by Internet Service Providers (ISP), with different unique addresses every time they access the Internet, there is a problem that home networks cannot be accessed from an outside network.

In other words, since Internet communications are connected through a worldwide communication network, transmitting and receiving data based on the regulations commonly applied to communications, the computers connected to the Internet require unique addresses that can distinguish one from another for data transmission and reception. However, since different IP addresses are provided by ISPs to the modem users every time they access the Internet, the IP addresses occupied are hardly recognizable from outside. Furthermore, the number of IP addresses are not enough, in the present IP address format, to provide unique IP addresses to all information appliances at homes.

For a better understanding, a brief description will be made on how to locate a desired address in the Internet.

An Internet address is usually expressed by numbers or English characters. The Internet address of numbers is called an IP address and is used for distinguishing between the communication devices in a network, such as computers, while the Internet address of English characters is called a domain name, which is designed for the users' convenience. Further, every communication device connected to the Internet has to have a unique address of numbers or English characters which is exclusively used by one user.

FIG. 1 is a view for showing a process of the use of a domain name when a general user accesses an Internet communication.

If a domain name is inputted through a web browser of a user computer U, the web browser requests a Domain Name Server (DNS), an IP address corresponding to the domain name through the Internet, the DNS searches a database of its own in response to the request of the web browser and provides the requested IP address corresponding to the domain name, and the web browser gives and takes data to and from a web server having the corresponding domain name in use of the IP address received.

As stated above, a domain name system converts a domain name expressed in English characters into an IP address expressed in numbers. Further, in order for one to use somebody else's domain name in the Internet, the domain name associated with an IP address should be registered in an authorized DNS server.

An IP address corresponding to a domain name is required in order to receive the domain name service as stated above. Therefore, since the domain name service is not provided in the situation that an IP address is changeable, a home network cannot be accessed from outside.

Further, there is a problem in constructing a home network because a plurality of network terminals cannot share one public IP address when accessing the Internet. That is, since IP addresses are insufficient in number, not all the information appliances are provided with IP addresses. Accordingly, there is a great demand for making network communications available with the use of one shared IP address, and decreasing the use of the IP addresses.

Furthermore, a user directly installs network configuration information and various service servers if the user wishes to build a home network at home. However, it is not easy for general users who have insufficient knowledge related to networks to understand protocols and to configure servers.

### SUMMARY OF THE INVENTION

In order to solve the above problems, it is an object of the present invention to provide a gateway and a method for operating the same, capable of accessing a network from outside, sharing one public IP address by information appliances connected to the network, and managing the information appliances connected to the network at the entrance at homes or offices in order to enable users lacking relevant knowledge to easily build the network.

In order to achieve the above object, the gateway according to the present invention includes a first interface for communicating with information appliances connected to an internal network; a second interface for communicating with information appliances connected to an external network; and a controller for, if a control request with respect to any of the information appliances connected to the internal network is received from the information appliances connected to the external network, requesting a function performance to a corresponding appliance according to requested control contents.

In order to achieve the above object, the method for operating the gateway having a first interface for communicating with information appliances connected to an internal network, a second interface for communicating with information appliances connected to an external network, and a controller for enabling intercommunication between the information appliances connected to the internal and external networks, includes the steps of connecting the Internet upon an initialization of a system, and providing information on the information appliances connected to the internal network if an access request is transmitted from an information appliance connected to the external network; and if a control request with respect to any one of the information appliances connected to the internal network is received, requesting a function performance to the corresponding appliance according to requested control contents.

### BRIEF DESCRIPTION OF THE DRAWINGS

The above object and other advantages of the present invention will become more apparent by describing in detail a preferred embodiment thereof with reference to the attached drawings, in which:

FIG. 1 is a view for explaining a domain name service;

FIG. 2 is a view for showing a network construction having a gateway according to an embodiment of the present invention;

FIG. 3 is a view for showing a protocol stack of the gateway of FIG. 2;

FIG. 4 is a block diagram for showing the gateway of FIG. 2;

FIGS. 5A, 5B, 5C, and 5D are views for explaining a method for operating the gateway of FIG. 2;

FIG. 6 is a view for showing signal flows for explaining an access from the Internet with respect to the gateway of FIG. 2;

FIG. 7 is a view for showing signal flows for explaining a method for allocating a private IP address to the gateway of FIG. 2, building a data table, and a domain name service;

FIG. 8 is a view for showing signal flows for explaining a transmission/reception process of a home information appliance with an external information appliance through the gateway of FIG. 2; and

FIG. 9 is a view for showing an address-port conversion table stored in the gateway of FIG. 2.

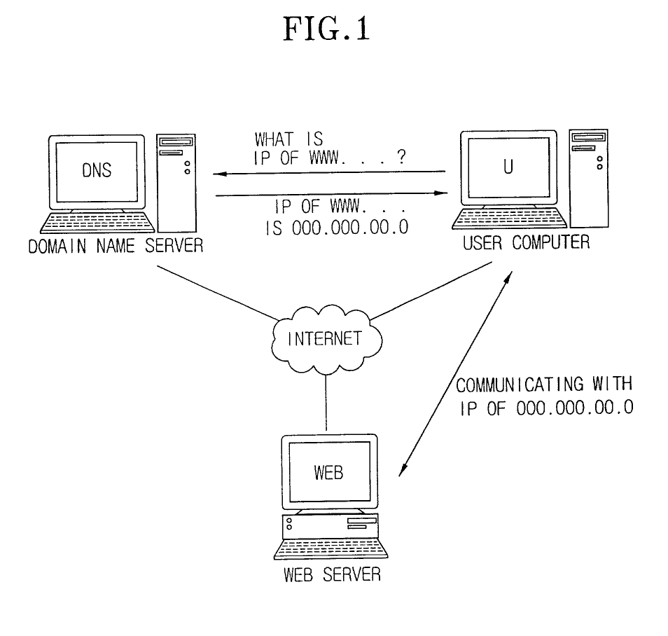

### DETAILED DESCRIPTION OF THE PREFERRED EMBODIMENTS

Hereinafter, some terms in the drawings and the detailed description are defined in order to explain a gateway according to an embodiment of the present invention.

HG, standing for a home gateway, indicates a system according to an embodiment of the present invention enabling intercommunications to be made between a home network and the Internet.

ISP, standing for an Internet service provider, indicates a server in the Internet which provides a public IP address available in the Internet in order for the HG to be connected to the Internet.

RD, standing for a remote device, indicates an information appliance remotely located with respect to a home network.

LD, standing for a local device, indicates information appliances, for example, an information electronic appliance such as a digital TV and an information terminal such as a computer, which are connected to a home network.

HG_DHCP, standing for a dynamic host configuration protocol of a home gateway, indicates a protocol for dynamically allocating a private IP address to an LD when the private IP address allocation is requested from the LD, as well as indicates a server for playing a role of the above in the drawings.

HG_DNS, standing for a domain name server of a home gateway, indicates, when an LD makes an inquiry into an address with respect to another LD or an RD, a server for providing a private or a public IP address to the corresponding LD or RD, as well as indicates a server for playing a role of the above in the drawings.

DNS, standing for a domain name server, indicates, when an inquiry into a public IP address is made through a domain name from an RD or a HG, a server for providing a corresponding public IP address in response to the inquiry, as well as indicates a server for playing a role of the above in the drawings.

An application proxy server is a server for playing a role of an agent of LDs when a control request with respect to the LDs connected to a home network occurs from an RD, provides to RDs services such as FTP, TELNET, embedded WEB, and the like, and requests function performances to the LDs.

Hereinafter, the present invention will be described in detail with reference to the attached drawings.

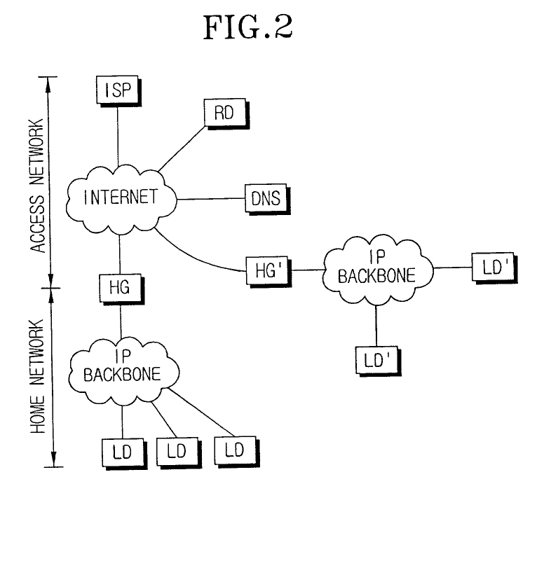

FIG. 2 is a view for showing a network construction having a gateway according to an embodiment of the present invention, in which LDs are interconnected through an IP backbone as well as connected to the Internet through an HG. Further, an ISP, a DNS server, and an RD are connected to the Internet, and LD's connected to another home network are connected to the Internet through an HG′.

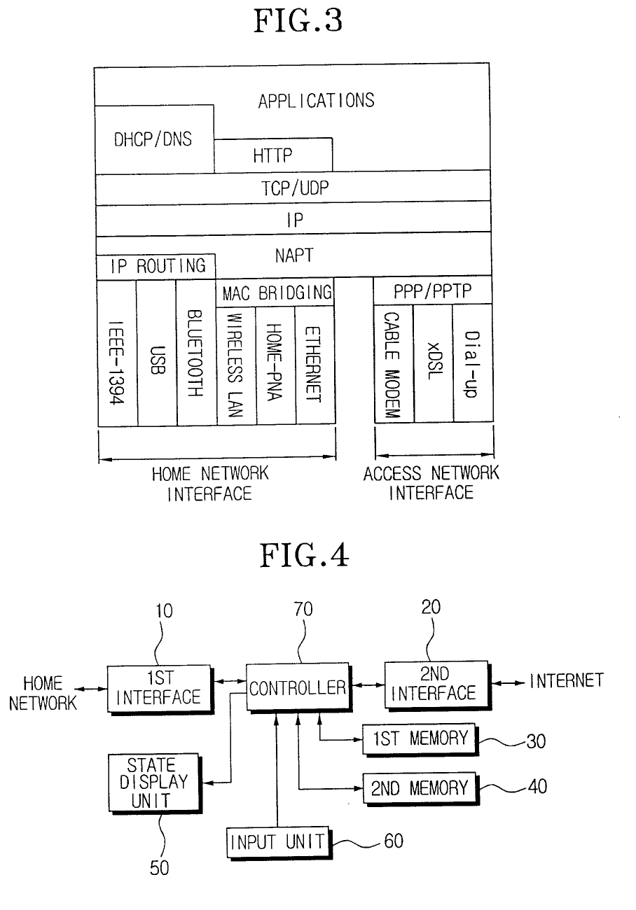

In the above network construction, an interface between the HG or HG′ (hereinafter, only HG is referred to) and a home network and an interface between the HG and the Internet are not limited to a specific physical layer, but can be used at any physical layer if having IP transmission capability. Further, access to the HG and the Internet is made through ADSL, CATV, PSTN, ISDN, and the like. Ethernet, home PNA, wireless LAN, IEEE 1394, and the like can be used between the HG and a home network. Furthermore, the HG may use an internal or an external modem to connect to an ISP, in which the internal modem and the external modem use the PPP protocol for the communications with the ISP and, in case of the external modem, the PPTP or the L2TP protocol is used between the HG and the modem. A network protocol stack of the gateway is shown in FIG. 3.

Referring to FIG. 2, the HG is provided with a unique domain name registered in the DNS server. Whenever connected to the Internet, the HG is allocated with a single public IP address from the ISP. Accordingly, whenever connected to the ISP, the registered domain name with the allocated public IP address should be registered in the DNS server in the Internet. The respective LDs are allocated with respective private IP addresses from the HG, and communicate with one another with the private IP addresses. The LDs access the Internet via the HG, and carry out a control command which is transmitted from the RD via the HG.

FIG. 4 is a block diagram for showing the home gateway of FIG. 2. As shown in FIG. 4, the gateway includes a first interface 10, a second interface 20, a first memory 30, a second memory 40, a state display unit 50, an input unit 60, and a controller 70.

The first interface 10 performs data transmission/reception with LDs connected to a home network. The second interface 20 performs data transmission/reception with RDs connected to the Internet. The first memory 30 stores a program for operating a system. The second memory 40 stores data transmitted through the first interface 10 or the second interface 20. For example, the second memory 40, as shown in FIG. 9, constructs an address and port conversion table from a data packet transmitted through the first interface 10 or the second interface 20 to a private IP address of an LD (L-ip), a LD port (L-port), a public IP address of an HG (G-ip), an HG port (G-port), an IP address of an RD (R-ip), and an RD port (R-port). The state display unit 50 displays the operational status of an appliance to be seen from the outside. The input unit 60 is used when manual manipulation is required with respect to the HG. Further, the controller 70 is allocated with a public IP address through the second interface 20 from an ISP server connected to the Internet upon initializing a system, and registers the allocated public IP address to be associated with a domain name registered in advance in a DNS server connected to the Internet. Furthermore, the controller 70 loads an HG_DHCP server from the first memory 30, allocates different private IP addresses to respective LDs through the first interface 10 and builds a database related to the private IP address allocations, and receives host names from the LDs having the allocated private IP addresses. The controller 70 transfers a database update request to a HG_DNS server and builds a database of the HG DNS server in association with the host names and the private IP addresses. The controller 70 also provides information on the LDs connected to the home network if an access request occurs through the Internet from an RD, and, if a control request with respect to either of the LDs connected to the home network is received from the access-requesting RD, requests a function performance suitable for a corresponding LD according to the requested control contents. Further, the controller 70 changes an origination address and a port to a public IP address and a port allocated upon a connection to the Internet to transmit a data packet from the LD to an RD connected to the Internet, and to a destination address in the Internet. For a transmission of a response data packet to the LD from the RD connected to the Internet, the controller 70 changes the public IP address and the port number to a private IP address and port with reference to the information recorded in the memory about the public IP address and the port included in the response data packet. Furthermore, if a home information appliance connected to a home network makes an inquiry about a private IP address through a host name with respect to another home information appliance connected to the same home network, the controller 70 provides the requested private IP address with reference to the database of the HG_DNS server.

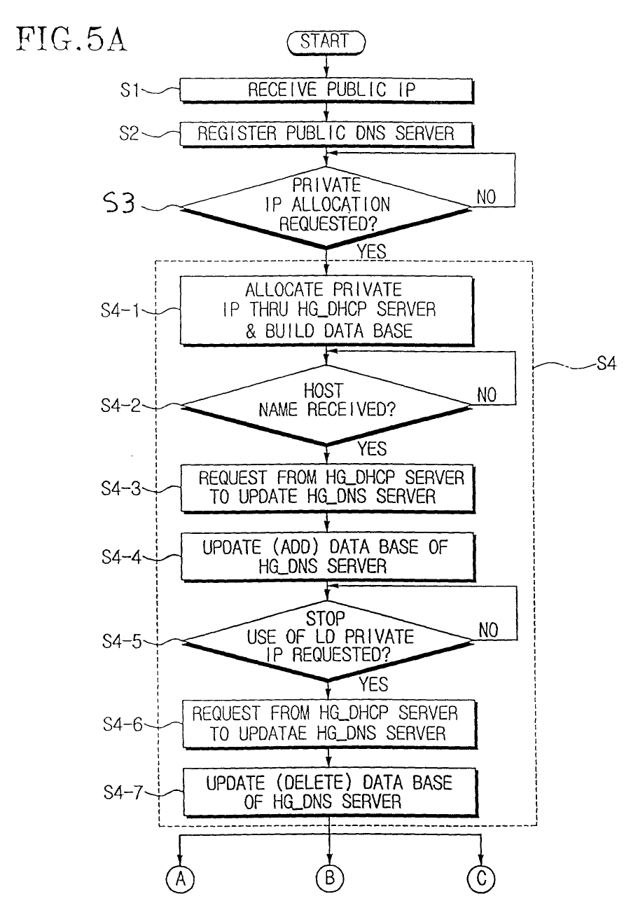

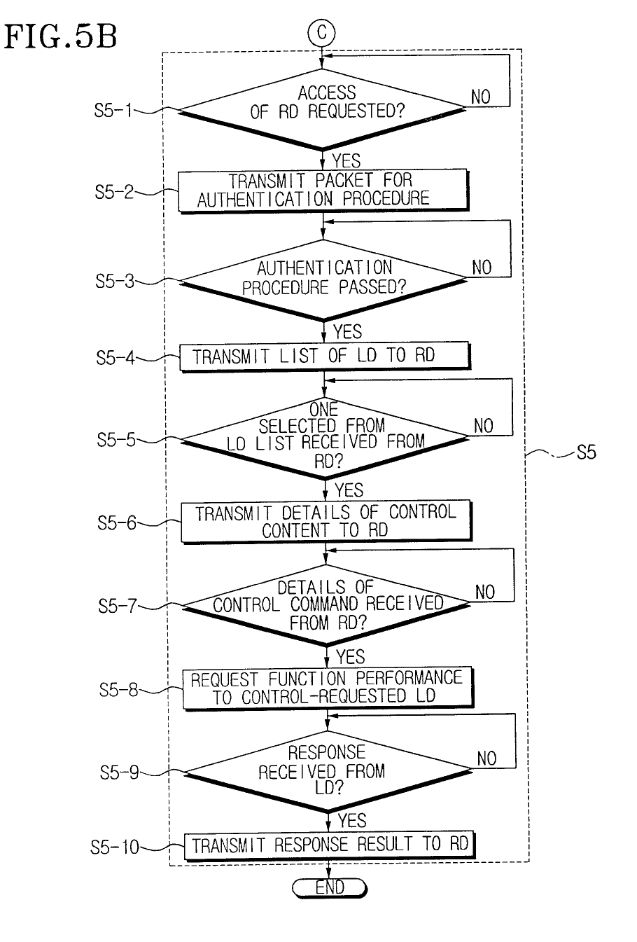

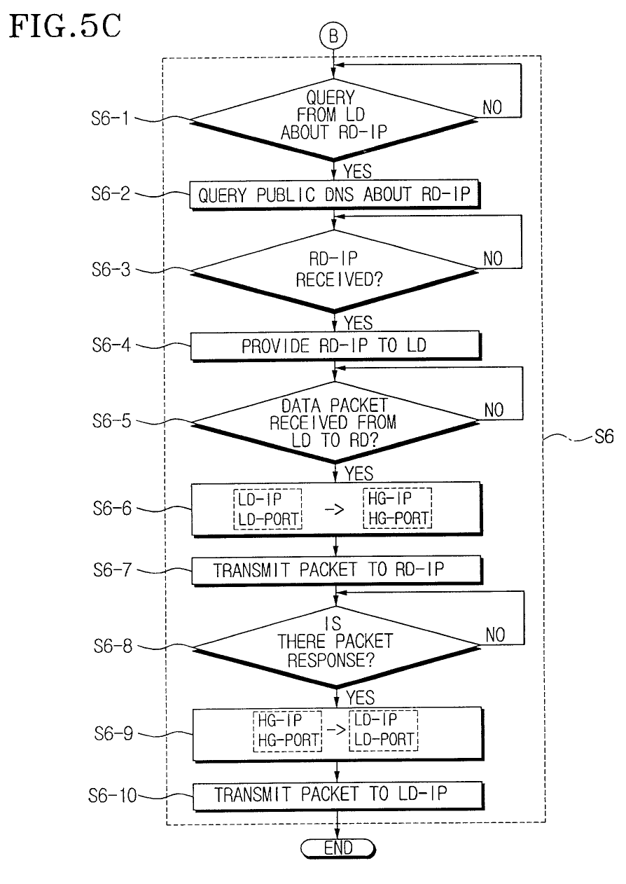

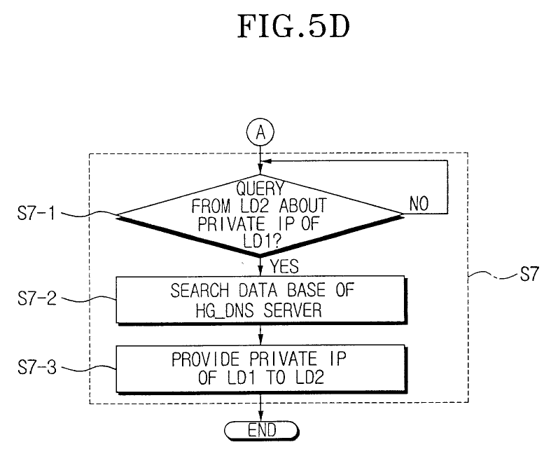

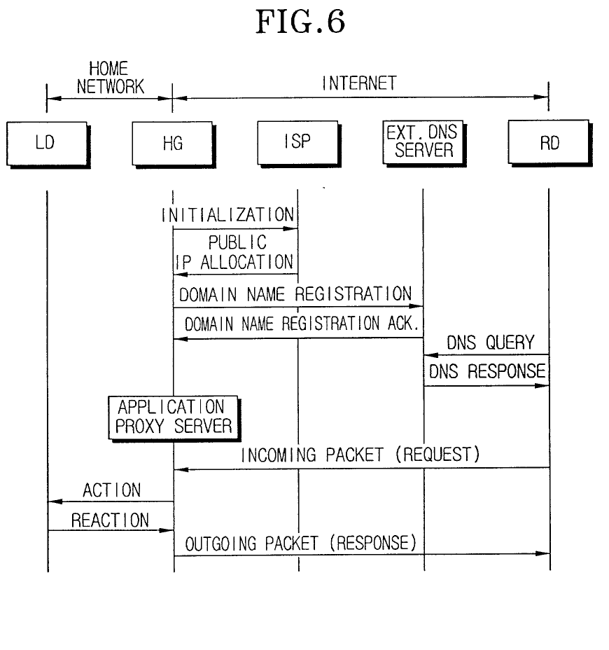

The operations of the gateway according to the embodiment of the present invention will be described with reference to the drawings of FIGS. 5A, 5B, 5C, and 5D for explaining a method for operating the gateway together with the drawings of FIGS. 6, 7, and 8 for showing signal flows.

First, referring to FIG. 5A, if activated, the HG receives a public IP address available in the Internet from the ISP connected to the Internet through the second interface 20 (step S1) and stores the received public IP address in the second memory 40. The HG further registers the received public IP address in a DNS server connected to the Internet to be associated with a domain registered in advance. FIG. 6 shows the signal flows of the above operation between the HG, ISP, and DNS server. An additional explanation of the DNS registration and the domain name in the above operations is provided below. That is, since a plurality of home networks exist in the Internet with the respective gateways distinguished by unique domain names of their own, the domain names cannot be arbitrarily chosen by users, but are allocated from the ISP in a manner in which they do not overlap with each other. As an example of obtaining a domain name available in the Internet and a home network, first, an ISP has to secure an authorized domain name such as <hww.co.kr>, while a user who accesses the Internet through the ISP has to obtain an ID from the ISP for an ISP connection, which is not overlapped with others such as <jhkim>, or the like. A combination of ID and the ISP, e.g, <jhkim.hww.co.kr> may be used for a domain name of the HG. Further, LDs may be arbitrarily provided by a user with the host names such as pc1, DTV1, and the like, which are not overlapped with one another. A combination of the host name and the domain name of the HG, e.g, <pc1.jhkim.hww.co.kr> may be used as a domain name of an LD. Such a domain name is available in a home network.

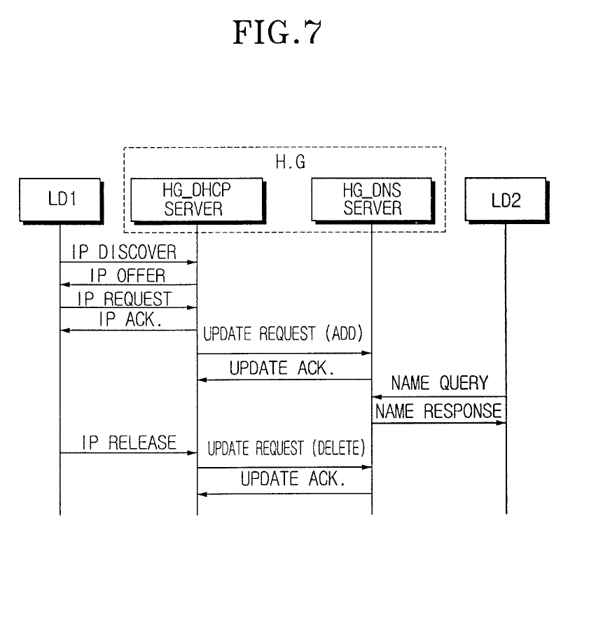

Referring to the sequence view of FIG. 5A, first, the DNS registration step (step S2) is performed. If requests for private IP address allocations are made by the LDs through the first interface 10 (step S3), private IP addresses are allocated to the LDs and a database related to the private IP address allocations is built (step S4). At this time, in the S4 for building the database, different private IP addresses are allocated through an HG_DHCP server loaded from the first memory 30 with respect to the private IP address allocation requests from home information appliances connected to a home network and a database is built according to the private IP address allocations (step S4-1). If the host names are transferred to the HG_DHCP server from the respective home information appliances allocated with the private IP addresses (step S4-2), update requests are made to the HG_DNS server loaded from the first memory (step S4-3) and a database for the HG_DNS server is built to be associated with the host names and allocated private IP addresses update-requested, regardless of the database which is built in accordance with the private IP address allocations (step S4-4). Further, if an interruption request of the use of a private IP address is made from an LD (step S4-5), the HG_DHCP server receives the request and transfers a delete update request of the requested LD to the HG_DNS server (step S4-6). The HG_DNS server receives the update request and deletes the contents related to the private IP address and the host name stored in the database (step S4-7). FIG. 7 shows the signal flows of the above operations between an LD1, an HG_DHCP server, and a HG_DNS server. An additional explanation of a private IP address is below. Since a home network is constructed based on the Internet protocol, information appliances at home have to have at least one unique IP address, respectively. However, with the 32-bit IP address system currently available, since the supply of the IP addresses cannot meet the demand, private IP addresses are used at home which are allowed by the Internet Assigned Numbers Authority (IANA). Further, since the demand of the IP address is not so much at home, the private IP addresses in the C class will be enough for use. The addresses of the C class allowed by the IANA range from 192.168.0.0-192.168.255.255. 192.168.255.255 is a sub-net mask.

The HG operations after the data base building steps of FIG. 5A will be described with reference to the flow chart of FIG. 5B, in which an external user wishes to control LDs. If an RD requests access to the HG wherein the RD has acquired an IP address through a domain name of the HG from a DNS server in the Internet (step S5-1), the HG transfers a packet to the RD for an authentication procedure (step S5-2). Therefore, if the packet undergoes the authentication procedure (step S5-3), a list of information appliances connected to a home network and having private IP addresses is transferred to the RD (step S5-4). Further, if a packet including information about a home information appliance selection is received from the RD (step S5-5), detailed control contents for the selected home information appliance are transferred (step S5-6). Therefore, if a detailed control request is received from the RD (step S5-7), the received request packet (Incoming packet (Request)) is grasped and a request for a function performance is made to a corresponding LD (step S5-8). If a response is transferred through the first interface from the corresponding LD (step S5-9), a response packet (Outgoing packet (Response)) is transferred to the RD through the second interface 20 according to the transferred response contents (step S5-10). As stated above, in case an external user wants to control an LD connected to a home network, an application proxy server of the HG is activated as an agent, and the HG performs its function in order for services such as FTP, Telnet, embedded WEB, and the like to be provided. The signal flows shown below the application proxy server indicates the above operations.

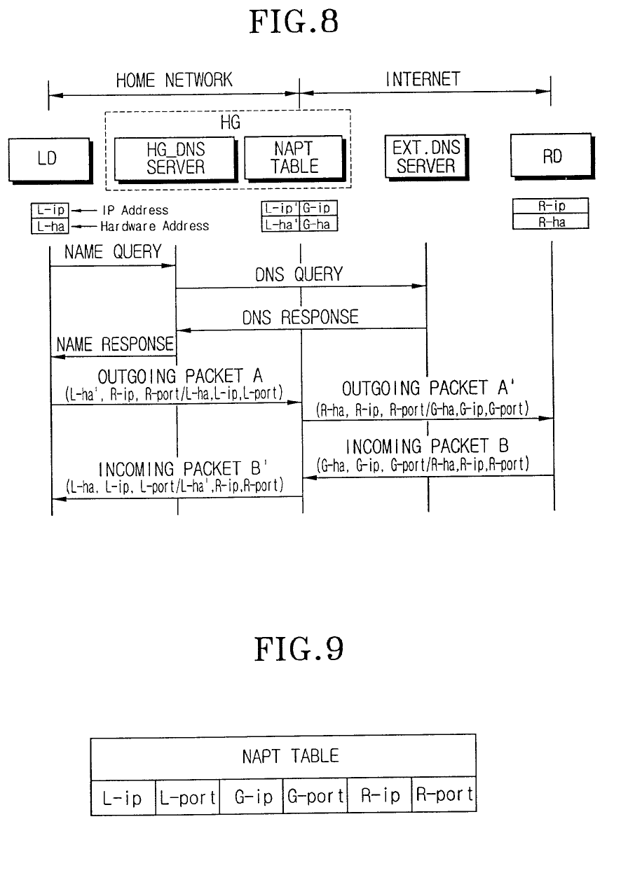

Further, FIG. 5C is a view for showing a flow of operations performed when a data packet is transferred from an LD to an RD. If an inquiry about an IP address is made through a domain of an RD from an LD in order to transfer data from the LD to the RD (step S6-1), an HG_DNS server makes an inquiry about an IP address of the RD with respect to a DNS server in the Internet (step S6-2). Therefore, if the IP address of the RD is received from the DNS server (EXT_DNS) in the Internet (step S6-3), the IP address of the RD is provided to the LD which requests the IP address (step S6-4). If a data packet (outgoing packet A) to be transmitted from the LD to the RD is transferred to the first interface 10 (step S6-5), a signal is changed according to an address and port conversion table stored in the second memory 40 as shown in FIG. 9 to change an origination address to an allocated public IP address (step S6-6). Next, a data packet (outgoing packet A′) having the public IP address and the port of the HG is transferred to a destination address through the second interface 20 (step S6-7). Therefore, if a data packet (incoming packet B) directed from the RD to the destination address of the public IP address is received at the second interface 20 (step S6-8), the received packet is changed to a data packet (incoming packet B′) according to the address and port conversion table as shown in FIG. 9, having the private IP address corresponding to a destination address (step S6-9) so as to be transmitted to a corresponding LD through the first interface 10 (step S6-10). The signal flows of FIG. 8 indicate the above operations (step S6).

With the use of the above method according the present invention, the respective information appliances at home only need to transmit private IP addresses and ports of their own to the gateway, where the private IP addresses and ports are recorded in association with respective output ports and changed to one output of a public IP address. Also, since a response packet transmitted to the public IP address can be transferred to a corresponding appliance according to contents included in the response packet, the plurality of information appliances can share one public IP address.

FIG. 5D is a flow chart showing communicating steps between the LDs after the database building steps (step S4). If an inquiry about a private IP address of an LD1 is made from an LD2 through the first interface 10 (step S7-1), a database recorded in the HG_DNS server is searched (step S7-2) and the private IP address of the LD1 is provided to the LD2 (step S7-3). In FIG. 7, the signal flows between the HG_DNS server and the LD2 indicate the above step (step S7).

As stated above, with a gateway according to the present invention, which operates in response to the contents of a received packet, and mounted at an internal network entrance, the Internet may be used through internal information appliances while an external user also may control information appliances connected to an internal network.

Further, home network users can build a network without having to go through the complicated installations of protocols into account.

Still further, sharing one public IP address with a plurality of appliances solves the problem of the IP addresses shortage in the Internet.

Furthermore, communications can be made with other information appliances connected to an internal network through familiar names instead of hard-to-memorize IP addresses.

Although the preferred embodiments of the present invention have been described, it will be understood by those skilled in the art that the present invention should not be limited to the descried preferred embodiments, but various changes and modifications can be made within the spirit and scope of the present invention as defined by the appended claims.

What is claimed is:

1. A gateway, comprising:
a first interface which communicates with information appliances connected to an internal network;
a second interface which communicates with information appliances connected to an external network; and
a controller which, if a control request with respect to either of the information appliances connected to the internal network is received from the information appliances connected to the external network, requests a function performance to a corresponding information appliance through the first interface according to requested control contents.

2. The gateway as claimed in claim 1, wherein the controller includes:
a DHCP server which allocates and manages different private IP addresses in accordance with a private IP address allocation request from the information appliances connected to the internal network, and receives host names from the information appliances allocated with the private IP addresses;
a DNS server which builds a database in order for the host names and the private IP addresses to be associated in response to an update request from the DHCP server; and
an application proxy server which transmits a list of the information appliances connected to the internal network in accordance with an access request of the information appliances connected to the external network, and transmits contents which control an information appliance selected from the transmitted list, and, if a control command is transmitted, requests a function performance to a corresponding information appliance according to the requested control command.

3 The gateway as claimed in claim 2, wherein the private IP addresses allocated to the information appliances connected to the internal network by the DHCP are the C class addresses defined by the Internet Assigned Numbers Authority (IANA).

4. The gateway as claimed in claim 2, wherein the DNS server builds the database by combining a domain name of the gateway and the host names of the information appliances connected to the internal network at a home, the domain name being registered in advance in an authorized DNS server connected to the external network.

5. The gateway as claimed in claim 4, wherein the DNS server, if any one of the information appliances connected to the internal network makes an inquiry about a private IP address through the host name with respect to another appliance connected to the internal network, provides the requested private IP address with reference to the database.

6. The gateway as claimed in claim 2, wherein the DNS server, if any one of the information appliances connected to the internal network makes an inquiry about a public IP address through the domain name with respect to an information appliance connected to the external network, provides the requested public IP address through an inquiry about the public IP address to an authorized DNS server connected to the external network.

7. The gateway as claimed in claim 2, wherein the application proxy server, if a response to the control request is transmitted from the corresponding control-requested information appliance connected to the internal network, notifies the response result to the control-requesting information appliance connected to the external network.

8. The gateway as claimed in claim 2, wherein the DHCP server, if an interruption request of the use of a private IP address is transmitted from an information appliance connected to the internal network, requests the DNS server to delete the private IP address of the corresponding information appliance and contents related to the host name from the database.

9. The gateway as claimed in claim 1, wherein the controller, if a data packet to be transmitted from one of the information appliances connected to the internal network to one of the information appliances connected to the external network is transferred to the first interface, changes an origination address and a port from a private IP address and a port to a public IP address and a port of the gateway to be outputted to the external network through the second interface, and, if a data packet having a destination address and a port as the public IP address of the gateway is transferred from the external network to the second interface in response to the output, changes the public IP address and the port to the private IP address and the port of the corresponding information appliance to be outputted through the first interface.

10. A method for operating a gateway having a first interface which communicates with information appliances connected to an internal network, a second interface which communicates with information appliances connected to an external network, and a controller which communicates with the information appliances connected to the internal and the external networks, comprising steps of:
providing information on the information appliances connected to the internal network if an access request is transmitted from an information appliance connected to the external network; and
requesting a function performance to an appliance according to requested control contents if a control request with respect to the information appliances connected to the internal network is received from the information appliance connected to the external network.

11. The method as claimed in claim 10, wherein the step for providing the information on the information appliances connected to the internal network in response to the access request from the information appliance connected to the external network includes steps of:
providing a list of the information appliances connected to the internal network; and
providing, if any one of the information appliances is selected from the provided list, contents for controlling the selected information appliance.

12. The method as claimed in claim 10, further comprising a step of, if a response according to the request of the function performance from the information appliance connected to the internal network is transferred, transmitting a result to the control-requesting information appliance connected to the external network.

13. The method as claimed in claim 10, further comprising a step of registering a domain name of the gateway and a public IP address of a system to be associated to each other on an initialization of the system, the domain name being registered in advance in a DNS server authorized in the external network.

14. The method as claimed in claim 13, further comprising steps of:
allocating, if the public IP address of the system is registered in the authorized DNS server connected to the external network, different private IP addresses in response to requests of private IP address allocations from the information appliances connected to the internal network; and
receiving host names from the information appliances allocated with the private IP addresses and connected to the internal network, and building a database in order for the private IP addresses and the host names to be associated to each other.

15. The method as claimed in claim 14, wherein the private IP addresses allocated to the information appliances have C class address formats defined by Internet Assigned Numbers Authority (IANA).

16. The method as claimed in claim 14, wherein the step for building the database builds the database in names combined with the domain name of the gateway registered in advance in the authorized DNS server connected to the external network and the host names of the respective information appliances connected to the internal network.

17. The method as claimed in claim 14, further comprising a step of providing, if an inquiry about a public IP address is made through the domain name with respect to the information appliances connected to the external network from an information appliance connected to the internal network at a home, the public IP address through an inquiry to the authorized DNS server connected to the external network.

18. The method as claimed in claim 17, further comprising steps of:
changing, if a data packet to be transmitted from the information appliance receiving the public IP address of the information appliance connected to the external network to the external information appliances connected to the external network is transferred to the first interface, origination address and port from private IP address and port to public IP address and port of the gateway, and outputting the changed origination address and port to the external network through the second interface; and
changing, if a data packet having the public IP address of the gateway as destination address and port is transferred to the second interface from the external network in response to the data packet, the public IP address and port into the private IP address and port of a corresponding information appliance connected to the internal network, and outputting the converted private IP address and port through the first interface.

19. The method as claimed in claim 14, further comprising a step of providing, if a private IP address is inquired through a host name from any one of the information appliances connected to the internal network with respect to information appliances connected to an internal network at another home, a requested private IP address with reference to the database.

20. The method as claimed in claim 14, further comprising a step of deleting, if an interruption request of the use of a private IP address is transferred to the first interface from an information appliance connected to the internal network, the private IP address and contents of a host name of a corresponding information appliance from the built database.
